(19) United States
(12) Patent Application Publication
(10) Pub. No.: US 2022/0299151 A1
(43) Pub. Date: Sep. 22, 2022

(54) APPARATUS AND METHOD FOR PLACING A CASING PATCH IN CASING OF A WELLBORE

(71) Applicant: Paul Bernard Lee, Kelowna (CA)

(72) Inventors: Paul Bernard Lee, Kelowna (CA); Dayln Beazer, Calgary (CA)

(21) Appl. No.: 17/696,690

(22) Filed: Mar. 16, 2022

(30) Foreign Application Priority Data
Mar. 17, 2021 (GB) 2103677.7

(51) Int. Cl. F16L 55/165; E21B 29/10; E21B 23/04

(52) U.S. Cl. CPC F16L 55/165; E21B 29/10; E21B 23/04

(57) ABSTRACT

A casing patch expansion apparatus is described. Casing patch expansion apparatus comprises a body on which at least one deformable packer element is mounted. Casing patch expansion means comprises at least one hydraulic cylinder. An increase in fluid pressure in at least one hydraulic cylinder causes compression of deformable packer element to deform the deformable packer element into an outwardly deployed condition to deform a casing patch mounted to the apparatus against a casing in a wellbore. Casing patch retention means comprises at least one retaining element arranged to engage casing patch mounted to the apparatus to retain the casing patch on the apparatus. An increase in fluid pressure in the apparatus causes retaining element to release the casing patch to enable the apparatus to move relative to the casing patch.

### BACKGROUND OF THE INVENTION

The present disclosure relates to a casing patch expansion apparatus for placing a casing patch in casing of a wellbore. The present disclosure also relates a method of placing a casing patch in casing of a wellbore and an assembly of a casing patch and casing patch expansion apparatus.

In hydrocarbon production, wellbores are commonly lined with steel casing to prevent wellbore collapse and facilitate hydrocarbon production from different regions along the wellbore. For example, in some circumstances, the casing is perforated to enable hydrocarbon production at the location of the perforated casing.

However, during management of oil and gas reservoirs, it is desirable to be able to patch unwanted perforations and leaking casing both to prevent unwanted fluid or gas migrations in the annulus and to manage hydrocarbon production at different regions of the wellbore.

Methods of patching casing are known using inflatable packers to expand steel casing patches against the surface of the casing to be patched. However, such methods generally only expand the casing patch to a point at which the patch is not flush with the internal diameter of the casing. This leaves a restriction in the casing which can prevent or limit other downhole operations.

Furthermore, known casing patch methods can be complex to operate and require tool servicing on the surface for repeated operation.

Preferred embodiments of the present disclosure seek to overcome the above disadvantages of the prior art.

### BRIEF SUMMARY OF THE INVENTION

According to an aspect of the present disclosure, there is provided a casing patch expansion apparatus for placing a casing patch in casing of a wellbore, the apparatus comprising:

a body on which at least one deformable packer element is mounted;

casing patch expansion means comprising at least one hydraulic cylinder, wherein an increase in fluid pressure in said at least one hydraulic cylinder causes compression of said at least one deformable packer element to deform said at least one deformable packer element into an outwardly deployed condition to deform a casing patch mounted to the apparatus against casing in the wellbore, and wherein reduction of fluid pressure in said at least one hydraulic cylinder enables said at least one deformable packer element to expand to an undeployed condition;

casing patch retention means comprising at least one retaining element arranged to engage a casing patch mounted to the apparatus to retain said casing patch on the apparatus, wherein an increase in fluid pressure in said apparatus causes said at least one retaining element to release said casing patch to enable the apparatus to move relative to said casing patch.

This provides the advantage of a casing patch expansion apparatus that can simultaneously place, release and expand a casing patch by the single operation of increasing fluid pressure in the internal bore of the apparatus. By creating a differential pressure between the internal diameter of the apparatus and the annulus outside of the apparatus, the hydraulic cylinders deploy the expandable packer element to deform the casing patch. This differential pressure also releases the casing patch retention means to enable the apparatus to move relative to the casing patch. This apparatus is therefore simple for operators to use. The apparatus can also be used repeatedly downhole without having to be returned to the surface for servicing.

This also provides the advantage that by selecting the correct number of hydraulic cylinders, sufficient force can be generated to deform both the casing patch and casing such that the casing patch is flush with the internal diameter of the casing being patched. This is advantageous because it leaves no restriction in the casing after patching.

The apparatus may further comprise a plurality of hydraulic cylinders arranged to cause compression of said at least one deformable packer element to deform said at least one deformable packer element into an outwardly deployed condition in response to an increase in fluid pressure in each said hydraulic cylinder.

This provides the advantage that due to the modular nature of assembly of the apparatus, the number of hydraulic cylinders can be increased and decreased as required in a straightforward manner during assembly of the apparatus to provide the correct amount of differential pressure to deform a casing patch such that it is flush with the casing of the wellbore.

In a preferred embodiment, said at least one deformable packer element is elastomeric.

Said at least one deformable packer element may further comprise a deformable metallic outer cover.

This provides the advantage that the deformable packer element is resistant to corrosion from dissolved chemicals such as carbon dioxide and hydrogen sulphide, particularly when operating in high temperature wellbore environments. This also provides the advantage that if after multiple activations, the deformable packer element fails, the apparatus will still function and retain the deformable material in the tool without it falling into the wellbore.

This also provides the advantage that the deformable metallic outer cover has been found to reliably deform casing patches if the deforming force is sufficient, whereas elastomeric elements due to their elasticity may be less reliable.

In a preferred embodiment, said casing patch retention means comprises at least one piston having at its first end said at least one retaining element, wherein said at least one retaining element projects outwardly of the apparatus to engage a portion of a casing patch in use shaped to receive said at least one retaining element, wherein an increase in fluid pressure in said apparatus causes said at least one piston to move to retract said at least one retaining element from engagement with said casing patch.

This provides the advantage of a means of ensuring that the casing patch is released at the same time as fluid pressure is increased in the apparatus to deploy the deformable packer elements.

The apparatus may further comprise locking means arranged to hold said at least one piston in a position retaining said casing patch on said apparatus until the fluid pressure in said apparatus increases above a pre-determined threshold at which said locking means is arranged to release said at least one piston to release said casing patch from engagement with the apparatus.

In a preferred embodiment, said locking means comprises at least one protrusion formed on said piston arranged to engage a thread of said apparatus such that said piston can be screwed along said thread to a position in which said at least one retaining element engages a casing patch, and wherein said protrusion is formed from a material harder than said thread such that when fluid pressure in the apparatus increases over said pre-determined threshold, said protrusion is able to strip said thread to enable movement of the piston.

This provides the advantage of a means for both facilitating assembly of the apparatus and mounting a casing patch thereon, as well as providing a means to release the casing patch at a particular predetermined fluid pressure.

In a preferred embodiment, said thread is formed on a bushing insertable in said apparatus.

This provides the advantage of a means of facilitating assembly of the apparatus and enabling servicing for re-use.

According to another aspect of the present disclosure, there is provided a method of placing a casing patch in casing of a wellbore, the method comprising mounting a casing patch to a casing patch expansion apparatus as defined above to form an assembly of a casing patch and casing patch expansion tool;

mounting said assembly in a work string and deploying the work string in casing in a wellbore at a position at which the assembly is located at a portion of casing at which a casing patch is required;

increasing fluid pressure in the apparatus of said assembly to both activate the casing patch expansion means and casing patch retention means to deform the casing patch into the surface of the casing in the well bore and release the casing patch from engagement with the casing patch retention means.

This provides the advantage of a casing patch expansion method which simultaneously places, releases and expands a casing patch by the single operation of increasing fluid pressure in the internal bore of the apparatus. By creating a differential pressure between the internal diameter of the apparatus and the annulus outside of the apparatus, the hydraulic cylinders deploy the expandable packer element to deform the casing patch. This differential pressure also releases the casing patch retention means to enable the apparatus to move relative to the casing patch. This apparatus is therefore simple for operators to use. The apparatus can also be used repeatedly downhole without having to be returned to the surface for servicing.

This also provides the advantage that by selecting the correct number of hydraulic cylinders, sufficient force can be generated to deform both the casing patch and casing such that the casing patch is flush with the internal diameter of the casing being patched. This is advantageous because it leaves no restriction in the casing after patching.

The method may further comprise reducing fluid pressure in the apparatus of said casing patch expansion apparatus to retract said at least one deformable packer element into the inwardly retracted condition to enable the casing patch expansion tool to be moved relative to the casing patch.

The method may further comprise moving said casing patch expansion apparatus relative to said casing patch and increasing fluid pressure in the casing patch expansion apparatus to reactivate said at least one deformable packer element to deform a portion of said casing patch into said casing.

According to a further aspect of the present disclosure, there is provided an assembly of a casing patch and casing patch expansion apparatus as defined above.

The assembly may further comprise an elastomeric sleeve disposed on the outer surface of said casing patch.

This provides the advantage of improving the sealing capability of the casing patch.

### BRIEF DESCRIPTION OF THE DRAWINGS

Preferred embodiments of the present disclosure will now be described by way of example only and not in any limitative sense, with reference to the accompanying drawings in which:

FIG. 1a is a longitudinal cross-section of a casing patch expansion apparatus for placing a casing patch in casing of a wellbore, the apparatus shown in assembly with a casing patch to be deployed in a casing of a wellbore;

FIG. 1b is a longitudinal cross-section of the assembly of casing patch expansion apparatus and casing patch of FIG. 1a shown in a perforated wellbore casing;

FIG. 2a is a close-up longitudinal cross-section of the casing patch retention means of the apparatus with FIGS. 1a and 1b;

FIG. 2b is a cross-section taken along line a-a of FIG. 2a;

FIG. 3a is a side view of the casing patch expansion apparatus of FIGS. 1a and 1b showing the deformable packer element in the outwardly deployed condition deforming a casing patch;

FIG. 3b is a side view corresponding to FIG. 3a showing the apparatus and deformed casing patch located in perforated casing in a wellbore;

FIG. 4 is a longitudinal cross-section of a number of casing patch expansion apparatuses in the same work string in use to expand a long casing patch;

FIG. 5 is a longitudinal cross-section of two casing patch expansion apparatuses of FIGS. 1a and 1b spaced apart by a length of tubing to expand casing patches at two different regions of casing;

FIG. 6a is a longitudinal cross-sectional view of a casing patch expansion apparatus of a second embodiment of the present disclosure; and

FIG. 6b is a longitudinal cross-section of the casing patch expansion apparatus of FIG. 6a showing the deformable packer element and deformable metallic outer cover in the outwardly deployed condition.

### DETAILED DESCRIPTION OF THE INVENTION

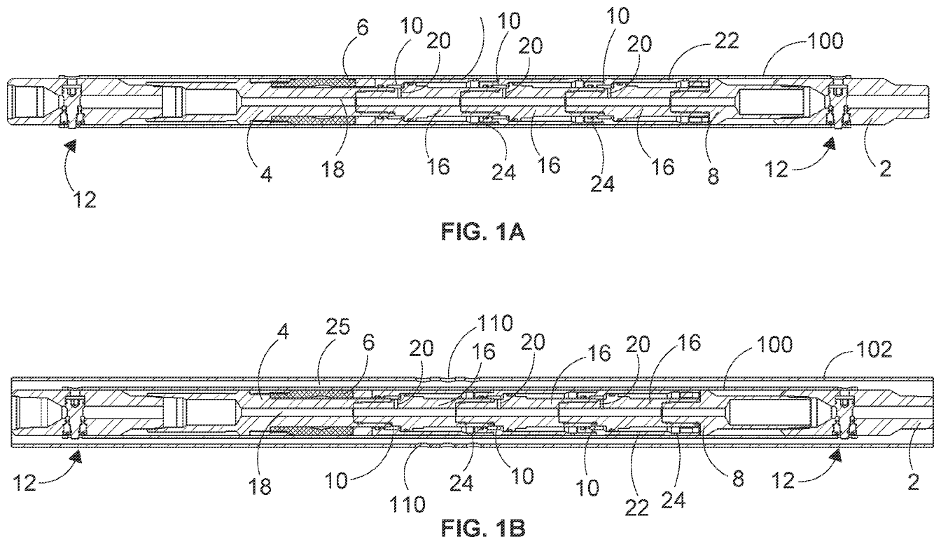

Referring to FIGS. 1a and 1b a casing patch expansion apparatus 2 comprises a body 4 on which at least one deformable packer element 6 is mounted. Casing patch expansion means 8 comprises at least one hydraulic cylinder 10. An increase in fluid pressure in at least one hydraulic cylinder 10 causes compression of the at least one deformable packer element 6 to deform the deformable packer element into an outwardly deployed condition to deform a casing patch 100 mounted to the apparatus 2 against a casing 102 in a wellbore. Reduction of fluid pressure in at least one hydraulic cylinder 10 enables at least one deformable packer element 6 to expand to an undeployed condition. The undeployed condition of the deformable packer element 6 is shown in FIGS. 1a and 1b.

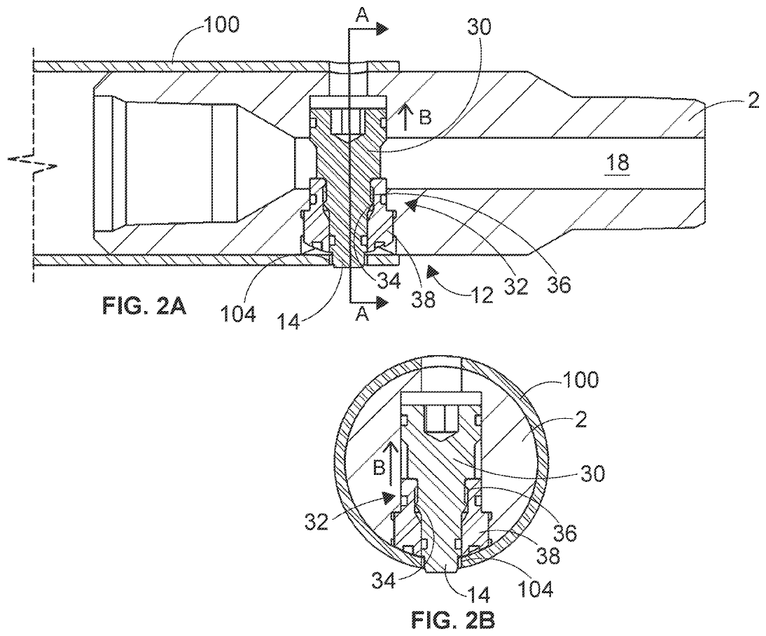

Referring to FIGS. 1a, 1b, 2a and 2b casing patch expansion apparatus 2 also comprises casing patch retention means 12 comprising at least one retaining element 14 arranged to engage casing patch 100 mounted to the apparatus to retain the casing patch 100 on the apparatus 2. An increase in fluid pressure in the apparatus 2 causes retaining element 14 to release the casing patch 100 to enable the apparatus 2 to move relative to the casing patch 100.

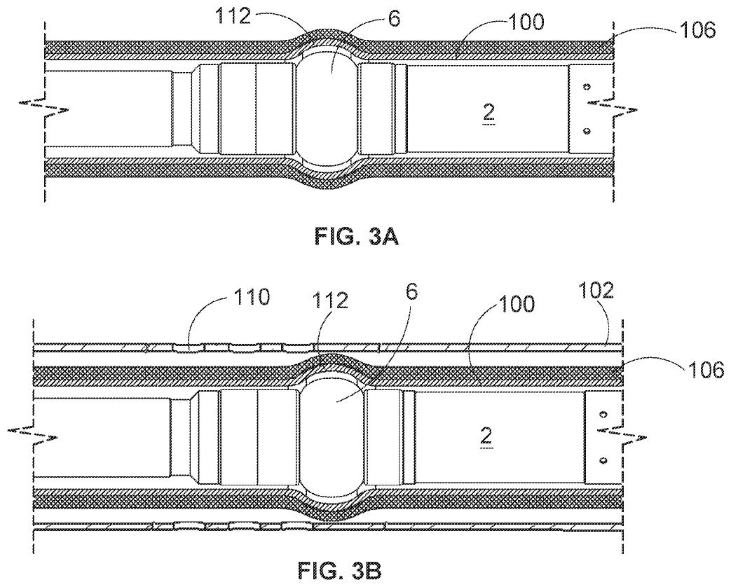

Referring to FIGS. 1a and 1b, hydraulic cylinders 10 are formed by interconnection of multiple body elements 16 defining a longitudinal bore 18 through the apparatus. A plurality of internal ports 20 enable fluid to flow from longitudinal bore 18 into each hydraulic cylinder 10. Externally of each body element 16 are outer cover elements 22 having annular ports 24 to enable fluid to be exhausted into the annulus outside of the apparatus 2. Consequently, when fluid pressure increases in the apparatus 2 and particularly in the internal bore 18, fluid pressure increases in hydraulic cylinders 10. When the differential pressure between hydraulic cylinders 10 and the outside annulus 25 which is in fluid communication with the outside of hydraulic cylinders 10 through annular ports 24 exceeds a pre-determined threshold, the deformable packer elements 6 are compressed by expansion of hydraulic cylinders 10 to the outwardly deployed condition as shown in FIGS. 3a and 3b.

The principle of operation to deploy the deformable packer elements 6 is identical to that disclosed in U.S. Pat. No. 9,869,163 B2, the disclosure of which is incorporated herein by reference.

Referring to FIGS. 2a and 2b, casing patch retention means 12 comprises at least one piston 30 having at its first end retaining element 14 which projects into a cut-out 104 of casing patch 100. An increase in fluid pressure in longitudinal bore 18 of the apparatus 2 causes piston 30 to move in the direction of arrow B in FIGS. 2a and 2b to retract the retaining element 14 from engagement with the cut-out 104 to disengage the apparatus 2 from the casing patch 100.

Locking means 32 is arranged to hold piston 30 in position in which retaining element 14 retains the casing patch 100 on the apparatus 2 until fluid pressure in the longitudinal bore 18 of the apparatus 2 increases above a pre-determined threshold. In a preferred embodiment, locking means 32 comprises at least one protrusion 34 formed on piston 30. Protrusion 34 engages a screw thread 36 formed in a bushing 38 which is insertable in the apparatus 2. To therefore assemble the casing patch retention means 12, the piston 30 is firstly inserted into apparatus 2 and the bushing 38 is then inserted on top of the piston. A hex key or similar can then be used to screw protrusions 34 of the piston 30 along screw thread 36 until the retaining element 14 projects through the cut-out of the casing patch 100.

When it is required to deform and release the casing patch 100, a fluid pressure increase in longitudinal bore 18 deforms deformable packer element 6 in the manner set out above. The same increase in fluid pressure over a pre-determined threshold causes protrusions 34 of piston 30 to strip thread 36 in bushing 38 because the piston 30 is made from a harder material than the thread 36. This enables piston 30 to move upwardly in the direction of arrow B and release the casing patch 100.

Referring to FIGS. 3a and 3b, deformation of a casing patch is shown. The deformable packer element 6 which may be elastomeric deforms casing patch 100 into perforated wellbore casing 102. Elastomeric sleeve 06 may be mounted on the outside of casing patch 100 to provide an improved seal.

Referring to FIGS. 1a, 1b, 2a, 2b, 3a and 3b, the operation of casing patch expansion apparatus 2 to place a casing patch in a wellbore will now be described.

Operators at the surface firstly mount casing patch 100 on casing patch expansion apparatus 2 by assembling casing patch retention means 12 and screwing piston 30 into the position shown in FIGS. 2a and 2b in which the retaining element 14 projects through cut-out 104 in the casing patch 100. The apparatus 2 is then mounted in a drill string and deployed downhole in a wellbore containing casing 102. At a point in the wellbore in which the casing patch is required, for example in the region of perforations 110 to seal the perforations 110 and prevent further fluid travel through the perforations 110, operators on the surface pump fluid into longitudinal bore 18 along the work string in which the apparatus 2 is incorporated.

This fluid increases fluid pressure in hydraulic cylinders 10 and once a pre-determined threshold is reached, two things happen. Firstly, hydraulic cylinders 10 expand to compress deformable packer elements 6 into the condition shown in FIGS. 3a and 3b and secondly, the locking means releases by virtue of piston protrusions 34 stripping thread 36 to move retaining element 14 out of cut-out 104 to release the casing patch.

A first deformation 112 is therefore created in the casing patch 100. By controlling the fluid pressure in the apparatus 2, sufficient force can be generated to deform both the casing patch 100 and casing 102 such that the casing patch 100 is flush with the internal diameter of the casing being patched. This is advantageous because it leaves no restriction in the casing after patching.

The operator then reduces fluid pressure in longitudinal bore 18 which returns the deformable packer elements 6 to the condition shown in FIGS. 1a and 1b by virtue of their inherent elasticity. Operators then move the apparatus along the wellbore and reactivate the deformable element 6 by increasing fluid pressure to make a further deformation in casing 100. For example, if the deformation 112 created is approximately 4 inches in length, the operators would move the apparatus 4 inches along the wellbore to create a second deformation. Multiple repetitions of this cycle can then be made to deform the whole of the casing patch.

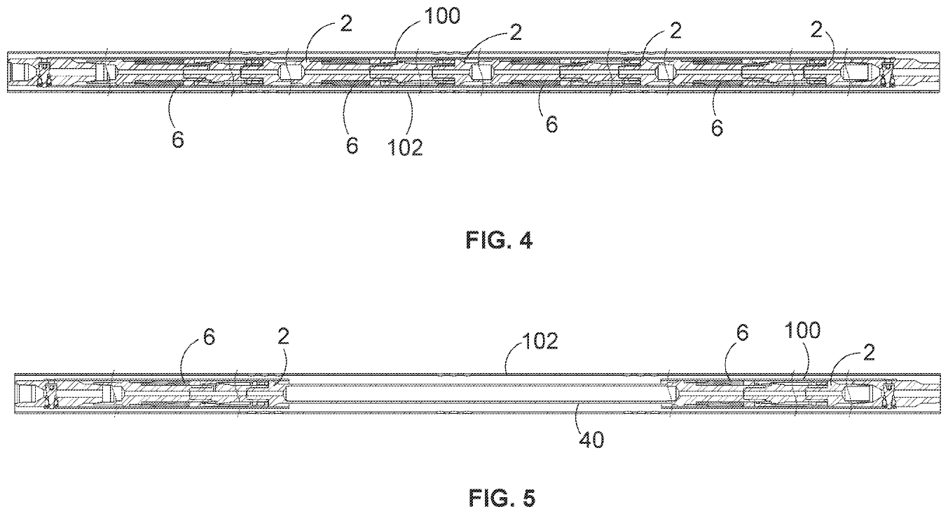

Referring to FIG. 4, multiple apparatuses 2 each having deformable packer element 6 can be used in a string along a wellbore to deform a long casing patch 100 into long lengths of wellbore. The use of multiple casing expansion apparatuses 2 in a modular form allow a string to deform a long casing patch 100. This is advantageous because it reduces the number of activations required to expand a long casing patch. For example, if a single apparatus 2 was used to expand a long casing patch 100 of length 10 ft, the apparatus might have to be activated 40 times, or 4 activations per foot. Using a second expander would reduce the number of activations by half which is advantageous because the integrity of the packer element 6 will eventually fail. Also, this reduces rig time and cost.

Alternatively, referring to FIG. 5, casing patch expansion apparatuses 2 can be separated by lengths of tubing 40 depending on the location of areas of casing 102 to be patched.

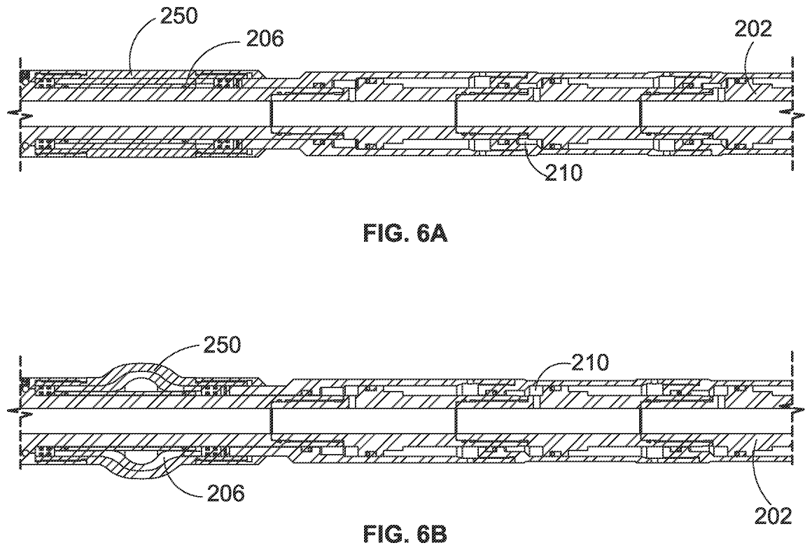

Referring to FIGS. 6a and 6b, a second embodiment of the casing patch expansion apparatus is shown with parts common to the embodiment of FIGS. 1 to 3 shown with like reference numerals, but increased by 200.

Casing patch expansion apparatus 202 comprises hydraulic cylinders 210 which operate to expand deformable packer element 206 in the same manner as that described in relation to the embodiment of FIGS. 1a and 1b. However, a deformable metallic outer cover 250 is mounted on the outside of deformable packer element 206. Deformable metallic outer cover 250 may be formed from a nickel-based alloy such as Inconel alloy 625. This material is sufficiently soft and ductile that it can be used as an outer cover in high pressure and temperature and corrosive downhole environments. The deformable metallic outer cover 250 deforms and expands in the same manner as the elastomeric deformable packer element 206.

It will be appreciated by persons skilled in the art that the above embodiments have been described by way of example only and not in any limitative sense, and that various alterations and modifications are possible without departure from the scope of the invention as defined by the appended claims.

1. A casing patch expansion apparatus for placing a casing patch in casing of a wellbore, the apparatus comprising:
a body on which at least one deformable packer element is mounted;
a casing patch expansion device comprising at least one hydraulic cylinder, wherein an increase in fluid pressure in said at least one hydraulic cylinder causes compression of said at least one deformable packer element to deform said at least one deformable packer element into an outwardly deployed condition to deform a casing patch mounted to the apparatus against casing in the wellbore, and wherein reduction of fluid pressure in said at least one hydraulic cylinder enables said at least one deformable packer element to expand to an undeployed condition;
a casing patch retention device comprising at least one retaining element arranged to engage a casing patch mounted to the apparatus to retain said casing patch on the apparatus, wherein an increase in fluid pressure in said apparatus causes said at least one retaining element to release said casing patch to enable the apparatus to move relative to said casing patch.

2. An apparatus according to claim 1, further comprising a plurality of hydraulic cylinders arranged to cause compression of said at least one deformable packer element to deform said at least one deformable packer element into an outwardly deployed condition in response to an increase in fluid pressure in each said hydraulic cylinder.

3. An apparatus according to claim 1, wherein said at least one deformable packer element is elastomeric.

4. An apparatus according to claim 1, wherein said at least one deformable packer element further comprises a deformable metallic outer cover.

5. An apparatus according to claim 1, wherein said casing patch retention device comprises at least one piston having at its first end said at least one retaining element, wherein said at least one retaining element projects outwardly of the apparatus to engage a portion of a casing patch in use shaped to receive said at least one retaining element, wherein an increase in fluid pressure in said apparatus causes said at least one piston to move to retract said at least one retaining element from engagement with said casing patch.

6. An apparatus according to claim 5, further comprising a locking device arranged to hold said at least one piston in a position retaining said casing patch on said apparatus until the fluid pressure in said apparatus increases above a pre-determined threshold at which said locking device is arranged to release said at least one piston to release said casing patch from engagement with the apparatus.

7. An apparatus according to claim 6, wherein said locking device comprises at least one protrusion formed on said piston arranged to engage a thread of said apparatus such that said piston can be screwed along said thread to a position in which said at least one retaining element engages a casing patch, and wherein said protrusion is formed from a material harder than said thread such that when fluid pressure in the apparatus increases over said pre-determined threshold, said protrusion is able to strip said thread to enable movement of the piston.

8. An apparatus according to claim 7, wherein said thread is formed on a bushing insertable in said apparatus.

9. A method of placing a casing patch in casing of a wellbore, the method comprising mounting a casing patch to a casing patch expansion apparatus according to claim 1 to form an assembly of a casing patch and casing patch expansion tool;
mounting said assembly in a work string and deploying the work string in casing in a wellbore at a position at which the assembly is located at a portion of casing at which a casing patch is required;
increasing fluid pressure in the apparatus of said assembly to both activate the casing patch expansion device and casing patch retention device to deform the casing patch into the surface of the casing in the well bore and release the casing patch from engagement with the casing patch retention device.

10. A method according to claim 9, further comprising reducing fluid pressure in said casing patch expansion apparatus to retract said at least one deformable packer element into the inwardly retracted condition to enable the casing patch expansion tool to be moved relative to the casing patch.

11. A method according to claim 10, further comprising moving said casing patch expansion apparatus relative to said casing patch and increasing fluid pressure in the casing patch expansion apparatus to reactivate said at least one deformable packer element to deform a portion of said casing patch into said casing.

12. An assembly of a casing patch and casing patch expansion apparatus according to claim 1.

13. An assembly accordingly to claim 12, further comprising an elastomeric sleeve disposed on the outer surface of said casing patch.
